(19) United States
(12) Patent Application Publication
(10) Pub. No.: US 2011/0247759 A1
(43) Pub. Date: Oct. 13, 2011

(54) FOCUS RING AND SUBSTRATE MOUNTING SYSTEM

(75) Inventors: Tsuguo KITAJIMA, Nirasaki City (JP); Yoshiyuki Kobayashi, Nirasaki City (JP); Jun Watanabe, Shibukawa City (JP); Takuya Okada, Omuta City (JP)

(73) Assignee: TOKYO ELECTRON LIMITED, TOKYO (JP)

(21) Appl. No.: 13/036,368

(22) Filed: Feb. 28, 2011

(30) Foreign Application Priority Data
Mar. 1, 2010 (JP) 2010-044345

(51) Int. Cl. B30B 15/34

(52) U.S. Cl. 156/583.1

(57) ABSTRACT

A focus ring surrounds an outer periphery of a substrate mounted on a mounting table having a temperature control mechanism and includes a contact surface which comes into contact with the mounting table and a heat transfer sheet formed on the contact surface. The heat transfer sheet contains an organic material and a heat transfer material mixed with the organic material, and has a film thickness larger than or equal to about 40 μm and smaller than about 100 μm.

### CROSS-REFERENCE TO RELATED APPLICATIONS

This application claims priority to Japanese Patent Application No. 2010-044345 filed on Mar. 1, 2010, the entire contents of which are incorporated herein by reference.

### FIELD OF THE INVENTION

The present invention relates to a focus ring and a substrate mounting system; and, more particularly, to a focus ring provided in a substrate mounting system so as to surround an outer periphery of a substrate.

### BACKGROUND OF THE INVENTION

When a plasma process, e.g., an etching process, is performed on a wafer as a substrate, it is required to uniformly maintain a temperature over the entire surface of the wafer during the etching process. This is because an etching rate in each portion of the wafer is affected by a temperature of the corresponding portion of the wafer.

A substrate processing apparatus for performing an etching process on a wafer includes: a depressurizable chamber for accommodating a wafer; and a substrate mounting system, provided in the chamber, for mounting the wafer thereon. A plasma is generated in the depressurized chamber, and the wafer is etched by the plasma. The substrate mounting system has a cylindrical susceptor for mounting thereon the wafer and a focus ring surrounding an outer periphery of the wafer mounted on the susceptor. The focus ring is made of a material substantially same as that of the wafer, so that a plasma can be distributed throughout a space above the focus ring as well as above the wafer. Accordingly, the uniformity of the etching process performed on the entire surface of the wafer can be maintained.

When the etching process is performed on the wafer, the temperature of the wafer varies due to heat from the plasma. The temperature of the wafer affects distribution of radicals in the plasma above the wafer. Therefore, if temperatures of a plurality of wafers in the same lot vary, it is difficult to perform a uniform etching process on the wafers in the same lot. For that reason, the susceptor of the substrate mounting system is provided with a temperature control mechanism. In the process of etching the wafers in the same lot, each of the wafers is cooled and controlled to a desired temperature by the temperature control mechanism for cooling a wafer.

When the etching process is performed on the wafer, the temperature of the focus ring varies due to the heat from the plasma. The temperature of the focus ring varies and, thus, the temperature of the outer periphery of the wafer also varies due to the effect of the temperature variation of the focus ring. Hence, the temperature of the focus ring needs to be controlled to a desired level by the temperature control mechanism of the susceptor in the process of etching the wafers in the same lot. However, the focus ring is merely mounted on the susceptor, and the adhesivity between the focus ring and the susceptor is low, so that thermal conductivity between the focus ring and the susceptor is decreased. As a result, it is difficult to control the temperature of the focus ring to a desired level.

To that end, the present inventors have developed a method for improving thermal conductivity between a focus ring and a susceptor and actively controlling a temperature of the focus ring by a temperature control mechanism of the susceptor (see, e.g., Japanese Patent Application Publication No. 2002-16126 and its corresponding U.S. Patent Application Publication No. 20020029745). In this method, the thermal conductivity is improved by disposing a heat transfer sheet between the focus ring and the susceptor.

However, the heat transfer sheet uses silicon rubber as a base material. Therefore, if a thickness of the heat transfer sheet is increased, heat resistance of the heat transfer sheet is increased, and the temperature of the focus ring is not decreased to a desired level. In other words, a film thickness of the heat transfer sheet which is suitable for a plasma process has not yet been found.

### SUMMARY OF THE INVENTION

In view of the above, the present invention provides a focus ring having a heat transfer sheet having a film thickness suitable for a plasma process and a substrate mounting system.

In accordance with a first aspect of the present invention, there is provided a focus ring which surrounds an outer periphery of a substrate mounted on a mounting table having a temperature control mechanism, the focus ring including: a contact surface which comes into contact with the mounting table; and a heat transfer sheet formed on the contact surface. The heat transfer sheet contains an organic material and a heat transfer material mixed with the organic material, and has a film thickness larger than or equal to about 40 μm and smaller than about 100 μm.

Further, thermal conductivity of the heat transfer sheet may be within a range of about 0.5 to 5.0 W/m·K. The organic material may be a heat-resistant adhesive or rubber containing silicon. The heat transfer material may be an oxide, a nitride or a carbide ceramic filler. The filler may be contained in the heat-resistant adhesive or rubber at about 25 to 60 vol %.

In accordance with a second aspect of the present invention, there is provided a substrate mounting system including: a mounting table for mounting thereon a substrate on which a predetermined process is performed; and a focus ring surrounding an outer periphery of the substrate mounted on the mounting table.

The mounting table includes a temperature control mechanism, and the focus ring has a contact surface which comes into contact with the mounting table and a heat transfer sheet formed on the contact surface, the heat transfer sheet containing an organic material and a heat transfer material mixed with the organic material and having a film thickness larger than or equal to about 40 μm and smaller than about 100 μm.

### BRIEF DESCRIPTION OF THE DRAWINGS

The objects and features of the present invention will become apparent from the following description of embodiments, given in conjunction with the accompanying drawings, in which:

FIG. 1 is a cross sectional view schematically showing a configuration of a plasma processing apparatus including a focus ring in accordance with an embodiment of the present invention;

FIG. 2 is an enlarged cross sectional view schematically showing a portion around a focus ring, a heat transfer sheet and a focus ring mounting surface of the plasma processing apparatus shown in FIG. 1;

FIG. 3 illustrates portions of a wafer where etching rates are measured while varying a film thickness of the heat transfer sheet;

FIG. 4 is a cross sectional view for explaining an eroded portion of a conventional focus ring; and

FIG. 5 is a graph showing relationship the film thickness of the heat transfer sheet and a temperature difference between the focus ring and the focus ring mounting surface.

### DETAILED DESCRIPTION OF THE EMBODIMENTS

An embodiment of the present invention will be described with reference to the accompanying drawings which form a part hereof.

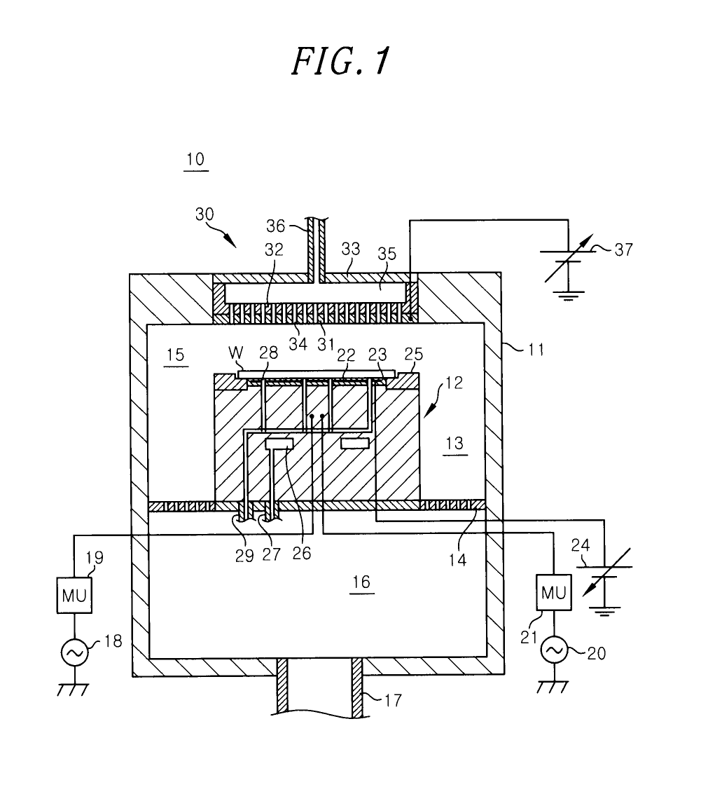

FIG. 1 is a cross sectional view schematically showing a configuration of a plasma processing apparatus including a focus ring in accordance with an embodiment of the present invention. This plasma processing apparatus performs a plasma etching process on a substrate, e.g., a wafer for a semiconductor device.

Referring to FIG. 1, a plasma processing apparatus 10 includes a chamber 11 for accommodating therein a wafer having a diameter of, e.g., about 300 mm, and a cylindrical susceptor 12 (mounting table) for mounting thereon the wafer W is disposed in the chamber 11. Further, in the plasma processing apparatus 10, a side exhaust passageway 13 is defined by an inner sidewall of the chamber 11 and a side surface of the susceptor 12. A gas exhaust plate 14 is provided in the middle of the side exhaust passageway 13.

The gas exhaust plate 14 is a plate-shaped member having a plurality of openings, and serves as a partition plate for partitioning the chamber 11 into an upper space and a lower space. A plasma is generated in the upper space (hereinafter, referred to as a “processing chamber”) 15 of the chamber 11 partitioned by the gas exhaust plate 14. Further, the lower space (hereinafter, referred to as a “gas exhaust chamber (manifold)”) 16 of the chamber 11 is connected to a gas exhaust pipe 17 through which a gas in the chamber 11 is exhausted. The gas exhaust plate 14 traps or reflects the plasma generated in the processing chamber and hence prevents the plasma from leaking into the manifold 16.

A TMP (Turbo Molecular Pump) and a DP (Dry Pump) (both not shown) are connected to the gas exhaust pipe 17 and evacuate the chamber 11 to reduce a pressure in the chamber to a vacuum state. Specifically, the DP reduces the pressure in the chamber 11 from the atmospheric pressure to an medium vacuum state (e.g., about 1.3×10 Pa (0.1 Torr) or less), and the TMP operates together with the DP to reduce the pressure in the chamber 11 to a high vacuum state where the pressure therein is lower than the medium vacuum pressure (e.g., about 1.3×10⁻³ Pa (1.0×10⁻⁵ Torr) or less). Moreover, the pressure in the chamber 11 is controlled by an APC (Automatic Pressure Control) valve (not shown).

The susceptor 12 in the chamber 11 is connected to a first high frequency power supply 18 via a first matching unit (MU) 19 and also connected to a second high frequency power supply 20 via a second matching unit (MU) 21. The first high frequency power supply 18 supplies to the susceptor 12 a high frequency power of a relatively low frequency, e.g., about 2 MHz for ion attraction. Moreover, the second high frequency power supply 20 supplies to the susceptor 12 a high frequency power of a relatively high frequency, e.g., about 60 MHz for plasma generation. The susceptor 12 therefore functions as an electrode. Further, the first and the second matching unit 19 and 21 reduce reflections of the high frequency powers from the susceptor 12 in order to maximize the efficiency in supplying the high frequency powers to the susceptor 12.

An upper portion of the susceptor 12 has a large-diameter columnar portion and a small-diameter columnar portion which coaxially protrudes from the top surface of the large-diameter columnar portion, so that a stepped portion is formed at the upper portion of the susceptor 12 so as to surround the small-diameter columnar portion. An electrostatic chuck 23 made of ceramic and having therein an electrostatic electrode plate 22 is disposed on the top of the small-diameter columnar portion. The electrostatic electrode plate 22 is connected to a DC power supply 24. When a positive DC voltage is applied to the electrostatic electrode plate 22, a negative potential is generated on a surface of the wafer W which faces the electrostatic chuck (hereinafter, referred to as a “backside surface”). A potential difference is thus generated between the electrostatic electrode plate 22 and the backside surface of the wafer W. The wafer W is attracted to be held on the electrostatic chuck 23 due to a Coulomb force or a Johnson-Rahbeck force resulting from the potential difference.

Further, a focus ring 25 is mounted on the stepped portion formed at the upper portion of the susceptor 12 so as to surround the wafer W attracted and held on the electrostatic chuck 23. The focus ring 25 is made of silicon (Si), silicon carbide (SiC) or the like. In other words, the focus ring 25 is made of a semi-conductive material, so that the plasma is distributed throughout a space above the focus ring 25 as well as above the wafer W. Accordingly, the plasma density on a peripheral portion of the wafer W is made to be maintained at a level substantially equal to that on a central portion of the wafer W. This ensures the uniformity of the plasma etching performed on the entire surface of the wafer W.

An annular coolant chamber (temperature control mechanism) 26 extending, e.g., in a circumferential direction of the susceptor 12, is provided in the susceptor 12. A low-temperature coolant, e.g., cooling water or Galden (registered trademark), is supplied from a chiller unit (not shown) to the coolant chamber 26 through a coolant line 27 to be circulated in the coolant chamber 26. The susceptor 12 cooled by the low-temperature coolant cools the wafer W and the focus ring 25.

The electrostatic chuck 23 has a plurality of heat transfer gas supply holes 28 which opens toward the wafer W electrostatically attracted and held on the electrostatic chuck 23. The heat transfer gas supply holes 28 are connected to a heat transfer gas supply unit (not shown) via a heat transfer gas supply line 29. The heat transfer gas supply unit supplies a heat transfer gas, e.g., helium (He) gas, into a gap between the attracting surface and the backside surface of the wafer W through the heat transfer gas supply holes 28. The helium gas supplied to the gap described above efficiently transfers heat from the wafer W to the susceptor 12.

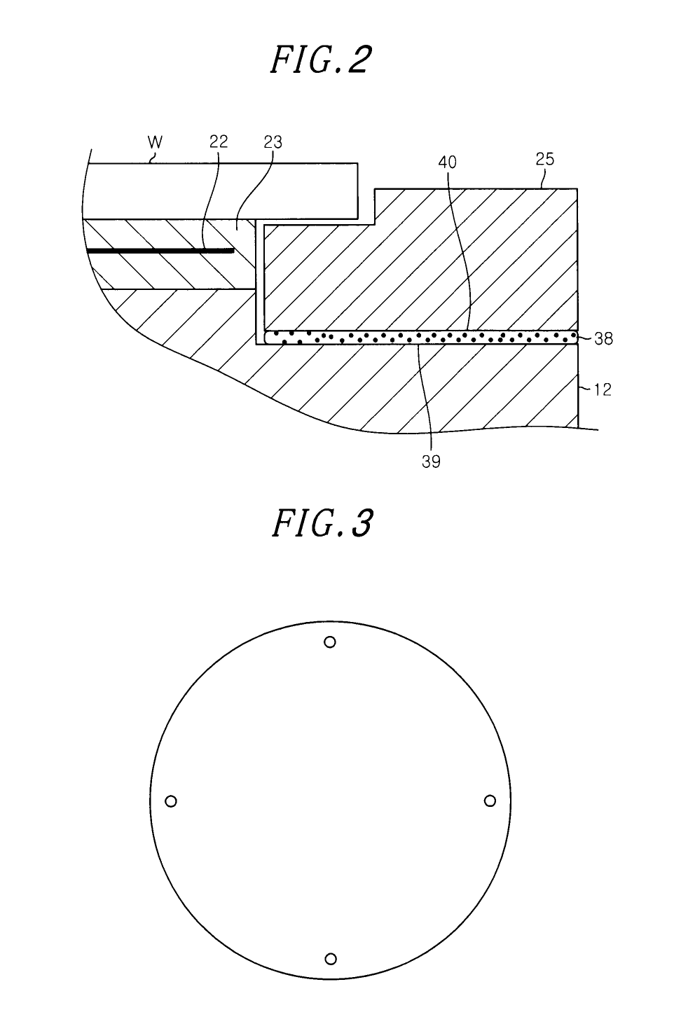

Moreover, a heat transfer sheet 38 to be described later is provided at a contact surface (hereinafter, referred to as a “susceptor contact surface”) 40 of the focus ring 25 which comes into contact with the stepped portion formed at the upper portion of the susceptor 12. The heat transfer sheet 38 fills fine gap generated between the susceptor contact surface 40 and the stepped portion (more specifically, a focus ring mounting surface 39 of the stepped portion), thereby improving the heat transfer efficiency between the focus ring 25 and the susceptor 12. As a consequence, the heat from the focus ring 25 is effectively transferred to the susceptor 12 (see FIG. 2).

In the present embodiment, the susceptor 12, the electrostatic chuck 23 and the focus ring 25 form a substrate mounting system.

A shower head 30 is provided at a ceiling portion of the chamber 11 to oppositely face the susceptor 12. The shower head 30 includes an upper electrode 31, a cooling plate 32 that detachably holds the upper electrode plate 31, and a lid 33 that covers the cooling plate 32. The upper electrode plate 31 is made of silicon as a semi-conductive material and is formed of a disc-shaped member having a plurality of gas holes 34 formed through the upper electrode plate 31 in a thickness direction. Moreover, a buffer room 35 is provided inside the cooling plate 32, and a processing gas inlet line 36 is connected to the buffer room 35.

Further, a DC power supply 37 is connected to the upper electrode plate 31 of the shower head 30, and a negative DC voltage is applied to the upper electrode plate 31. At this time, the upper electrode plate 31 emits secondary electrons to prevent decrease of electron density in the processing chamber 15.

In the plasma processing apparatus 10, the processing gas supplied from the processing gas inlet line 36 to the buffer room 35 is introduced into the processing chamber 15 through the gas holes 34. The introduced processing gas is excited and turned into a plasma by the high frequency power for plasma generation which is applied to the processing chamber 15 from the second high frequency power supply 20 via the susceptor 12. The ions in the plasma thus generated are attracted toward the wafer W by the high frequency power for ion attraction which is applied to the susceptor 12 from the first high frequency power supply 18, so that the wafer W is subjected to the plasma etching process.

The operations of components of the above-described plasma processing apparatus 10 is controlled based on a program corresponding to the plasma etching process by a CPU in a control unit (not shown) of the plasma processing apparatus 10.

FIG. 2 is an enlarged cross sectional view schematically showing a portion around a focus ring, a heat transfer sheet and a focus ring mounting surface of the plasma processing apparatus shown in FIG. 1.

Referring to FIG. 2, a flat portion of the stepped portion of the susceptor 12 forms the focus ring mounting surface 39 which comes into contact with the focus ring 25 mounted thereon. When the focus ring 25 is mounted on the focus ring mounting surface 30, the heat transfer sheet 38 of the focus ring 25 comes into contact with the focus ring mounting surface 39 and fills fine gap generated between the susceptor contact surface 40 of the focus ring 25 and the focus ring mounting surface 39 of the susceptor 12. Accordingly, the heat transfer efficiency between the focus ring 25 and the susceptor 12 is improved. As a result, the heat from the focus ring 25 is effectively transferred to the susceptor 12, so that the focus ring 25 can be cooled.

Here, the temperature of the focus ring 25 is increased up to about 200° C. despite cooling by the susceptor 12. Thus, the heat transfer sheet 38 requires heat resistance so that its shape can be maintained at a high temperature. For that reason, a heat-resistant organic material, e.g., heat-resistant adhesive or rubber containing heat-resistant silicon (hereinafter, referred to as a “silicon-containing heat-resistant material), is used as the base material of the heat transfer sheet 38. Moreover, a plurality of heat transfer fillers is squeezed and distributed in the heat transfer sheet 38. The heat transfer filler is made of, e.g., an oxide, a nitride or a carbide ceramic filler, and improves the thermal conductivity of the heat transfer sheet 38. The heat-resistant organic material may be heat-resistant epoxy, and a proper organic material is selected depending on types of plasma etching processes.

The upper portion of the susceptor 12, especially the focus ring mounting surface 39 has unevenness and roughness as a result of a cutting process. Due to the unevenness or the roughness of the surface, comparatively large gaps may be generated locally between the susceptor contact surface 40 and the focus ring mounting surface 39. In this case, if the heat transfer sheet 38 is excessively thin, the heat transfer sheet 38 cannot fill the gaps between the susceptor contact surface 40 and the focus ring mounting surface 39. In other words, the heat transfer sheet 38 cannot be tightly adhered to the focus ring mounting surface 39.

If the thickness of the heat transfer sheet 38 is increased, the combined heat capacity of the focus ring 25 and the heat transfer sheet 38 is increased, and the temperature increasing tendency of the focus ring 25 during the plasma etching process may become unsuitable for the plasma etching process.

Accordingly, the present inventors have studied and found that when the thickness of the heat transfer sheet 38 is larger than or equal to about 40 μm and smaller than about 100 μm, the heat transfer sheet 38 can be tightly adhered to the focus ring mounting surface 39 and, also, the temperature increasing tendency of the focus ring 25 can be maintained in a state suitable for the plasma etching process.

Hereinafter, a method for setting a minimum thickness of the heat transfer sheet 38 will be described.

If the heat transfer sheet 38 is excessively thin, the heat transfer sheet 38 is not tightly adhered to the focus ring mounting surface 39. Therefore, a temperature of a portion of the focus ring 25 which corresponds to the thin portion of the heat transfer sheet 38 is not decreased. Accordingly, a portion of the wafer W which faces the corresponding portion of the focus ring 25 is heated by the radiant heat from the focus ring 25, and the distribution of radicals in the plasma above the corresponding portion of the wafer W is changed. As a result, the etching rate at the corresponding portion of the wafer W during the plasma etching process becomes different from the etching rate at the other portions.

In order to obtain the film thickness of the heat transfer sheet 38 which allows the etching rate to vary within a tolerable range of about 10 nm/min, four heat transfer sheets 38 having different film thicknesses (about 25 μm, 26 μm, 27 μm and 40 μm) were prepared. Further, a plasma etching process was performed on twenty-five wafers W in a single lot by using the plasma processing apparatus 10 and variation in the etching rate of each of the wafers in the single lot was measured. In the plasma etching process, a silicon oxide film formed on the wafer W was etched, and a gaseous mixture of C₅F₈/Ar/O₂ was used as a processing gas.

Each of the heat transfer sheets 38 was manufactured in the following manner. In other words, XE14-B8530(A) (product of Momentive Performance Materials Inc.) and XE14-B8530(B) (product of Momentive Performance Materials Inc.) were used as polyorganosiloxane, and liquid in which both were mixed at a weight ratio of 1:1 (hereinafter, referred to as a “mixed liquid A”) was obtained. Next, DAM5 (product of ElectroChemical Industry Co., average particle diameter of about 5 μm) as an alumina filler was added to the mixed liquid A such that a volume ratio of the mixed liquid A to the alumina filler was about 60:40. Further, RD-1 (product of Dow Corning Toray Silicone, Co.) as a cross-linked polyorganosiloxane-based hardening agent was added at about 0.04 wt % with respect to the total weight of the mixed liquid A and the alumina filler and then stirred. The liquid thus obtained (hereinafter, referred to as a “mixed liquid B”) was coated on the focus ring to obtain a desired film thickness and hardened by heating at about 150° C. for about 30 hours, thereby forming each of the heat transfer sheets 38. When the heat transfer sheet 38 was formed by using a test piece on which only the mixed liquid B was hardened, the thermal conductivity of the corresponding heat transfer sheet 38 measured by a laser flash method was about 1.2 W/m·K.

FIG. 3 shows portions of each wafer where etching rates were measured while varying the film thickness of the heat transfer sheet. As shown in FIG. 3, the etching rate was measured at four points (indicated by “” in the drawing) spaced from each other at angles of 90° in the peripheral portion of each wafer. The measurement result is shown in following Table 1. In Table 1, the etching rate is denoted as E/R for convenience.

TABLE 1

| | | | | |
|---|---|---|---|---|
| Film thickness (μm) | 26 | 25 | 27 | 40 |
| Variation in E/R (nm/min) | 17.7 | 19.9 | 22.2 | 8.0 |

As can be seen from Table 1, when the film thickness of the heat transfer sheet 38 is larger than or equal to about 40 μm, the etching rate varies within the tolerable range. In other words, when the film thickness of the heat transfer sheet 38 is larger than or equal to about 40 μm, the heat transfer sheet 38 is tightly adhered to the focus ring mounting surface 39.

Hereinafter, a method for setting a maximum thickness of the heat transfer sheet 38 will be described.

When the heat transfer sheet 38 is excessively thick, the combined heat capacity of the focus ring 25 and the heat transfer sheet 38 is increased compared to the heat capacity of the focus ring having no heat transfer sheet (heat capacity of a conventional focus ring) and, also, the temperature increasing tendency of the focus ring 25 is changed compared to that of the conventional focus ring in such a manner that it is difficult to increase or decrease the temperature of the focus ring 25. The temperature of the focus ring 25 affects the distribution of the radicals in the plasma on the wafer W. Hence, if the temperature increasing tendency of the focus ring 25 is changed, a desired plasma etching process may not be performed on the wafer W.

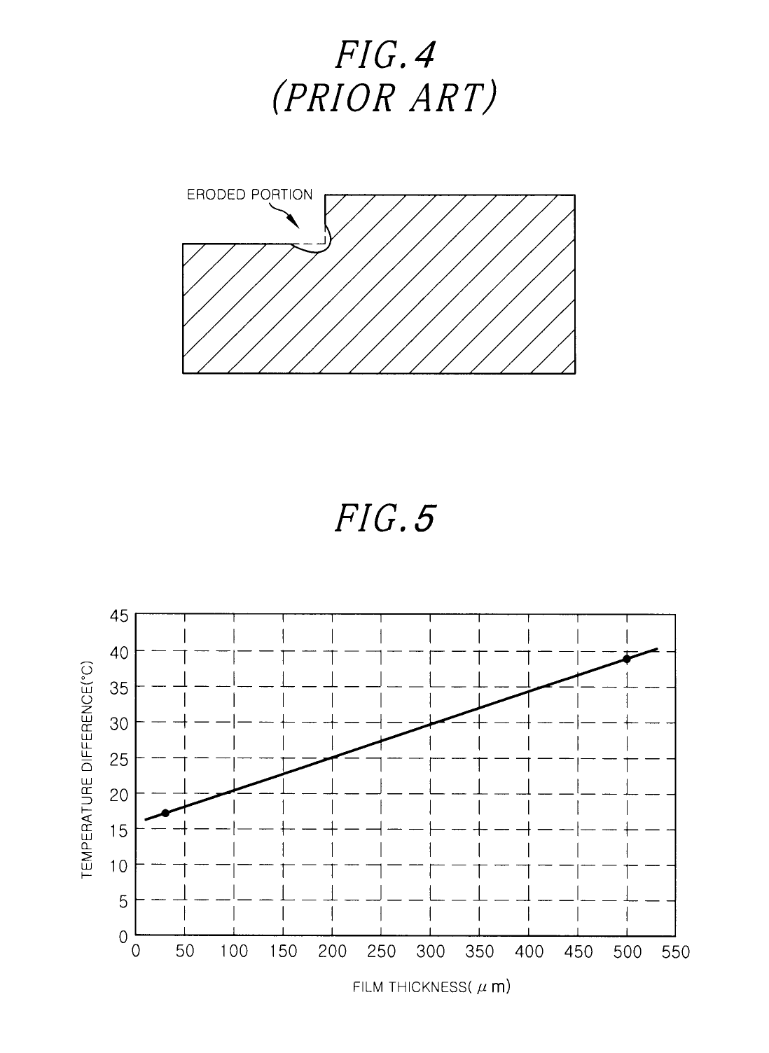

Meanwhile, as the plasma etching process is repeated, the focus ring is eroded by sputtering with positive ions in the plasma or the like. Especially, the portion of the focus ring which surrounds the peripheral portion of the wafer is eroded considerably (FIG. 4). When the focus ring is eroded, the heat capacity of the focus ring is changed and, thus, a desired plasma etching process may not be performed on the wafer W. To that end, conventionally, the focus ring is exchanged when the mass of the focus ring made of silicon is decreased by about 4.0%. In other words, since a mass of an object made of the same density material is in proportional to its volume, the change in the heat capacity which corresponds to a 4.0% decrease in the volume of the focus ring is allowed in view of the effects of the heat capacity on the plasma etching process.

The present inventors have examined the aforementioned allowable heat capacity variation (hereinafter, referred to as a “allowable heat capacity”) and have found a maximum thickness of the heat transfer sheet 38 based on the allowable heat capacity. Specifically, a heat capacity of silicon per unit mass is about 0.7 J/g·K, and a specific gravity of silicon is about 2.33 g/cm³. Thus, a heat capacity of the focus ring per unit volume is about 1.63 J/cm³·K, and the allowable heat capacity is calculated by the following equation (1):

Allowable heat capacity=1.63×thickness of focus ring×bottom area of focus ring×0.04 Eq. (1).

Further, a heat capacity of the heat-resistant adhesive forming the heat transfer sheet 38 per unit mass is about 1.0 J/g·K, and a specific gravity of the heat-resistant adhesive is about 2.1 g/cm³. Therefore, a heat capacity of the heat transfer sheet 38 per unit volume is about 2.1 J/cm³·K, and the heat capacity of the heat transfer sheet 38 is calculated by the following equation (2):

Heat capacity of heat transfer sheet=2.1×thickness of heat transfer sheet×bottom area of heat transfer sheet Eq. (2).

Here, the increase in the combined heat capacity of the focus ring 25 and the heat transfer sheet 38 with respect to the heat capacity of the conventional focus ring corresponds to the heat capacity of the heat transfer sheet 38. Therefore, when the heat capacity of the heat transfer sheet 38 is within the allowable heat capacity range, the increase in the heat capacity caused by the heat transfer sheet 38 is allowed in view of the effects of the heat capacity on the plasma etching process. In other words, the temperature increasing tendency of the focus ring 25 can be maintained in a state suitable for the plasma etching process. On the assumption that the bottom area of the focus ring and that of the heat transfer sheet are the same and the thickness of the focus ring is about 3.4 mm in the above equations (1) and (2), the maximum film thickness of the heat transfer sheet 38 can be calculated by the following equation (3):

Maximum film thickness of heat transfer sheet 38=1.63×0.34×0.04÷2.1=0.0106 (cm) Eq. (3).

Hence, when the film thickness of the heat transfer sheet 38 is smaller than or equal to about 106 μm, i.e., about 100 μm or less, the temperature increasing tendency of the focus ring 25 can be maintained in a state suitable for the plasma etching process.

Hereinafter, another method for setting a maximum thickness of the heat transfer sheet 38 will be described.

Since a heat-resistant material containing silicon is used as a base material of the heat transfer sheet 38, the increase in the thickness of the heat transfer sheet 38 leads to deterioration of the thermal conductivity of the heat transfer sheet 38. When the thermal conductivity of the heat transfer sheet 38 deteriorates, the temperature of the focus ring 25 is not decreased, and the peripheral portion of the wafer W surrounded by the focus ring 25 is heated by the radiant heat from the focus ring 25.

Meanwhile, the problem of the temperature variation of the wafer W electrostatically attracted and held on the electrostatic chuck 23 can be solved by the coolant chamber of the susceptor 12 and the heat transfer gas supply holes 28. Specifically, in case where the temperature difference between the central portion of the wafer W and the peripheral portion of the wafer W is less than about 20° C., the temperature of the central portion of the wafer W and that of the peripheral portion of the wafer W can be set to the same level by controlling the flow rate of the coolant in the coolant chamber 26 or the supply amount of He gas from the heat transfer gas supply holes 28. Accordingly, even though the peripheral portion of the wafer W is heated in a state where the thickness of the heat transfer sheet 38 is increased, the temperature of the central portion of the wafer W and that of the peripheral portion of the wafer W can be controlled to the same level by using the coolant chamber 26 and the heat transfer gas supply holes 28 if the temperature of the heated peripheral portion of the wafer W is higher than that of the central portion of the wafer W by less than about 20° C.

The temperature of the central portion of the wafer W is substantially the same as that of the susceptor 12 by the heat transfer of He gas, and the temperature of the peripheral portion of the wafer W does not become higher than that of the focus ring 25. Therefore, even if the thickness of the heat transfer sheet 38 is increased, the temperature of the peripheral portion of the wafer W which is heated by the radiant heat from the focus ring 25 does not become 20° C. or more higher than that of the central portion of the wafer W as long as the temperature difference between the focus ring 25 and the susceptor 12 (the focus ring mounting surface 39) is less than about 20° C.

Therefore, the present inventors obtained the relationship between the film thickness of the heat transfer sheet 38 and the temperature difference between the focus ring 25 and the focus ring mounting surface 39 and found, based on the above relationship, the film thickness of the heat transfer sheet 38 which allows the corresponding temperature difference to be less than about 20° C.

Specifically, the present inventors prepared three plate-shaped test pieces made of silicon. First, a temperature of a first plate-shaped test piece having no heat transfer sheet (hereinafter, referred to as a “first temperature”) was measured when irradiating a plasma thereon. Next, a second plate-shaped test piece was attached to the first plate-shaped test piece via a heat transfer sheet 38 having a film thickness of 30 μm and a temperature of the second plate-shaped test piece was measured (hereinafter, referred to as a “second temperature”) when irradiating a plasma thereon. Finally, a third plate-shaped test piece was attached to the first plate-shaped test piece via a heat transfer sheet 38 having a film thickness of 500 μm, and the temperature of the third plate-shaped test piece was measured (hereinafter, referred to as a “third temperature”) when irradiating a plasma thereon.

The first temperature corresponds to the temperature of the focus ring mounting surface 39; the second temperature corresponds to the temperature of the focus ring 25 with the heat transfer sheet 38 having the film thickness of 30 μm; and the third temperature corresponds to a temperature of the focus ring 25 with the heat transfer sheet 38 having the film thickness of 500 μm. Thus, the difference between the second temperature and the first temperature corresponds to a temperature difference between the focus ring 25 having the film thickness of 30 μm and the focus ring mounting surface 39, and the difference between the third temperature and the first temperature corresponds to a temperature difference between the focus ring 25 having the film thickness of 500 μm and the focus ring mounting surface 39. The present inventors plotted the difference between the second temperature and the first temperature and the difference between the third temperature and the first temperature in the graph of FIG. 5.

From the graph plotted in FIG. 5, the relationship between the film thickness of the heat transfer sheet 38 and the temperature difference between the focus ring 25 and the focus ring mounting surface 39 was obtained by first-order approximation.

The corresponding relationship is indicated by the following equation (4):

Temperature difference=0.047×film thickness of heat transfer sheet+15.6 Eq. (4).

The above equation (4) shows that the film thickness of the heat transfer sheet 38 is preferably about 93.6 μm, i.e., smaller than about 100 μm, in order to set the temperature difference between the focus ring 25 and the focus ring mounting table 39 to be less than about 20° C. Therefore, when the film thickness of the heat transfer sheet 38 is set to be smaller than about 100 μm, the temperature of the central portion of the wafer W and that of the peripheral portion of the wafer W can be maintained at the same level even when the radiant heat from the focus ring 25 is transferred to the peripheral portion of the wafer W.

In accordance with the focus ring of the present embodiment, the film thickness of the heat transfer sheet 38 formed between the susceptor contact surface 40 of the focus ring 25 and the susceptor 12 having the coolant chamber 26 is larger than or equal to about 40 μm and smaller than about 100 μm.

When the film thickness of the heat transfer sheet 38 is larger than or equal to about 40 μm, the heat transfer sheet 38 can be tightly adhered to the focus ring mounting surface 39 of the susceptor 12. Accordingly, the temperature of any portion of the focus ring 25 is not decreased.

When the film thickness of the heat transfer sheet 38 is smaller than about 100 μm, the combined heat capacity of the focus ring 25 and the heat transfer sheet 38 can be increased within a proper range. Therefore, the temperature increasing tendency of the focus ring 25 can be maintained in a state suitable for the plasma etching process, and the temperature difference between the focus ring 25 and the focus ring mounting surface 39 can be less than about 20° C. Accordingly, the temperature of the central portion of the wafer W and that of the peripheral portion of the wafer W can be maintained at the same level even when the radiant heat from the focus ring 25 is transferred to the peripheral portion of the wafer W.

In other words, when the film thickness of the heat transfer sheet 38 is larger than or equal to about 40 μm and smaller than about 100 μm, the film thickness of the heat transfer sheet 38 is suitable for a plasma etching process.

In the aforementioned focus ring, the heat transfer sheet 38 is made of a heat-resistant polyorganosiloxane-based adhesive containing silicon. Thus, the heat transfer sheet 38 is flexibly deformable and can be adhered to the focus ring mounting surface 39 of the susceptor 12 even if the focus ring mounting surface 39 is uneven. Further, the heat transfer material of the heat transfer sheet 38 is an oxide, a nitride or a carbide ceramic filler, and is contained in the heat transfer sheet 38 at about 25 to 60 vol %. In addition, the thermal conductivity of the heat transfer sheet 38 is within the range of about 0.5 to 5.0 W/m·K, so that the heat transfer sheet 38 can substantially uniformly transfer heat over the entire region thereof. As a result, the temperature of the entire focus ring 25 can be substantially uniformly controlled.

In the above-described embodiments, the substrate on which the plasma etching processing is performed is not limited to the wafer for a semiconductor device, but various substrates used for an LCD (Liquid Crystal Display) or an FPD (Flat Panel Displays) or a photomask, a CD substrate, a printed circuit board or the like may be used.

In accordance with the present embodiment, the heat transfer sheet of the focus ring formed on the contact surface which comes into contact with the mounting table having the temperature control mechanism has a film thickness larger than or equal to about 40 μm and smaller than about 100 μm. When the film thickness of the heat transfer sheet is larger than or equal to about 40 μm, the heat transfer sheet can be tightly adhered to the mounting table even if a contact surface of the mounting table which comes into contact with the focus ring is uneven or rough. Hence, the temperature of the focus ring can be controlled by the temperature control mechanism of the mounting table. When the film thickness of the heat transfer sheet is smaller than about 100 μm, the temperature increasing tendency of the focus ring is not changed even if the combined heat capacity of the focus ring and the heat transfer sheet is increased. Accordingly, the result of the plasma process on the substrate is not affected by the increase in the combined heat capacity. That is, the film thickness of the heat transfer sheet which is larger than or equal to about 40 μm and smaller than about 100 μm is suitable for the plasma process.

Further, the organic material of the heat transfer sheet is a heat-resistant adhesive or rubber containing silicon. Thus, the heat transfer sheet is flexibly deformable and can be tightly adhered to the mounting table even if the contact surface of the mounting table which comes into contact with the focus ring is uneven. Moreover, the heat transfer material of the heat transfer sheet is an oxide, a nitride or a carbide ceramic filler, and the filler is contained in the heat-resistant adhesive or rubber at about 25 to 60 vol %. As a consequence, the heat transfer sheet can transfer heat substantially uniformly over the entire region thereof. As a result, the temperature of the entire focus ring can be substantially uniformly controlled.

Further, when the thermal conductivity of the heat transfer sheet is within the range of about 0.5 to 5.0 W/m·K, the temperature of the focus ring can be effectively controlled by the temperature control mechanism of the mounting table. Especially, when the thermal conductivity is within the range of about 1.0 to 2.0 W/m·K, it is more preferable in that the temperature of the focus ring can be effectively controlled by the temperature control mechanism of the mounting table and, also, the heat transfer sheet having excellent conformability to unevenness or surface roughness on the contact surface of the mounting table which comes into contact with the focus ring can be obtained.

Further, the heat-resistant adhesive or rubber in the present embodiment is not particularly limited as long as silicon is contained therein. However, cross-linked polyorganosiloxane where a main chain thereof includes siloxane units is preferably used. Among polyorganosiloxanes, thermosetting polyorganosiloxane is preferably used. Further, it is preferable to use a hardening agent (cross-linked polyorganosiloxane) in addition to polyorganosiloxane as a main material. A repeating unit of polyorganosiloxane includes a dimethylsiloxane unit, a phenylmethylsiloxane unit, a diphenylsiloxane unit or the like. Besides, a modified polyorganosiloxane having a functional group such as a vinyl group, an epoxy group or the like may be used.

Further, the heat transfer material of the heat transfer sheet is an oxide, a nitride or a carbide ceramic filler. Specifically, the oxide includes alumina, magnesium oxide, zinc oxide, silica or the like; the nitride includes aluminum nitride, boron nitride, silicon nitride or the like; and the carbide includes silicon carbide or the like. Preferably, the ceramic filler has a spherical structure and if the ceramic filler has an anisotropic shape, it is oriented such that heat transfer characteristics can be maximized. As for the ceramic filler, it is more preferable to use alumina, zinc oxide, aluminum nitride, boron nitride, silicon nitride, silicon carbide or the like.

Furthermore, the heat transfer material is contained in the heat transfer sheet of the present embodiment at about 25 to 60 vol %. When the content ratio of the heat transfer material is within the above range, the heat transfer sheet is flexible enough to be tightly adhered to the contact surface of the mounting table which comes into contact with the focus ring even if the contact surface is uneven. Besides, the uniformity of the thermal conductivity of the heat transfer sheet is improved, so that the heat transfer sheet can transfer heat substantially uniformly over the entire region thereof without variation.

While the invention has been shown and described with respect to the embodiments, it will be understood by those skilled in the art that various changes and modification may be made without departing from the scope of the invention as defined in the following claims.

What is claimed is:

1. A focus ring which surrounds an outer periphery of a substrate mounted on a mounting table having a temperature control mechanism, the focus ring comprising:
a contact surface which comes into contact with the mounting table; and
a heat transfer sheet formed on the contact surface,
wherein the heat transfer sheet contains an organic material and a heat transfer material mixed with the organic material, and has a film thickness larger than or equal to about 40 μm and smaller than about 100 μm.

2. The focus ring of claim 1, wherein thermal conductivity of the heat transfer sheet is within a range of about 0.5 to 5.0 W/m·K; the organic material is a heat-resistant adhesive or rubber containing silicon; the heat transfer material is an oxide, a nitride or a carbide ceramic filler; and the filler is contained in the heat-resistant adhesive or rubber at about 25 to 60 vol %.

3. A substrate mounting system comprising:
a mounting table for mounting thereon a substrate on which a predetermined process is performed; and
a focus ring surrounding an outer periphery of the substrate mounted on the mounting table;
wherein the mounting table includes a temperature control mechanism, and wherein the focus ring has a contact surface which comes into contact with the mounting table and a heat transfer sheet formed on the contact surface, the heat transfer sheet containing an organic material and a heat transfer material mixed with the organic material and having a film thickness larger than or equal to about 40 μm and smaller than about 100 μm.
